(19) United States
(12) Patent Application Publication
(10) Pub. No.: US 2026/0289227 A1
(43) Pub. Date: Sep. 24, 2026

(54) APPARATUS AND METHOD FOR GENERATING A DANCE MOTION OF A ROBOT

(71) Applicants: HYUNDAI MOTOR COMPANY, Seoul (KR); KIA CORPORATION, Seoul (KR)

(72) Inventors: Jae Woo Lee, Hwaseong-si (KR); Se Hwan Kim, Hwaseong-si (KR); Chang Yong Shim, Hwaseong-si (KR)

(73) Assignees: HYUNDAI MOTOR COMPANY, Seoul (KR); KIA CORPORATION, Seoul (KR)

(21) Appl. No.: 19/306,410

(22) Filed: Aug. 21, 2025

(30) Foreign Application Priority Data
Mar. 18, 2025 (KR) 10-2025-0034566

(51) Int. Cl. G06N 3/008; B25J 9/16; G05B 13/02; G10H 1/00; G10L 15/04; G10L 15/183

(52) U.S. Cl. CPC G06N 3/008; B25J 9/1664; G05B 13/0265; G10H 1/0008; G10L 15/04; G10L 15/183; G10H 2210/076

(57) ABSTRACT

An apparatus and a method generate a dance motion of a robot. The apparatus analyzes music to be used to generate the dance motion and lyrics corresponding to the music to generate motion sets. Each of the motion sets is executable by a reference robot for each predetermined unit. The apparatus selects one motion set based on the result of proceeding with reinforcement learning for the motion sets by a predetermined epoch. The apparatus proceeds with additional reinforcement learning for the selected motion set to calculate first control values of each of a plurality of joints of the reference robot. The apparatus performs motion retargeting corresponding to a target robot for the first control values to calculate second control values of each of a plurality of joints of the target robot.

### CROSS-REFERENCE TO RELATED APPLICATION

This application claims the benefit of and priority to Korean Patent Application No. 10-2025-0034566, filed in the Korean Intellectual Property Office on Mar. 18, 2025, the entire contents of which are incorporated herein by reference.

### TECHNICAL FIELD

The present disclosure relates to technologies for generating a dance motion of a robot. More particularly, the present disclosure relates to technologies for generating a dance by a robot regardless of the type of robot based on musical characteristics and lyrics information.

### BACKGROUND

Robots such as robots with the ability to move and dance may be developed for entertainment and service. Controlling and generating different motions such as dance motions and movements require extensive development and resources.

One solution provided by conventional technology may include learning existing dance motion and enabling a robot to dance by receiving and learning input from a video. However, the process of producing and learning from a video as a guide by a robot is inconvenient and resource intensive.

Further, other solutions currently provided by conventional technology consider only musical characteristics such as rhythm, beat, and tempo. Therefore, since current technology does not consider lyrics of music, generation of movements and facial expressions by a robot that match the lyrics of the music is not currently possible.

### SUMMARY

The present disclosure has been made to solve the above-mentioned problems occurring in the prior art while maintaining other technological solutions.

An aspect of the present disclosure provides for automatic generation of a motion, e.g., a dance motion or movement, of a robot via reinforcement learning.

Another aspect of the present disclosure provides generation and mapping of a dance motion by different robots even though each robot may have different joints and shapes.

Another aspect of the present disclosure provides an apparatus and a method for identifying the content of the music including the meaning of the lyrics, as well as other music elements, such as beat and rhythm. In particular, the present disclosure provides generation of a dance motion of a robot based on the lyrics and the beat of the music.

Another aspect of the present disclosure provides an

apparatus and a method for allowing a robot to generate its own movements without a guide, such as a video.

Another aspect of the present disclosure provides an apparatus and a method for automatically mapping the movement of the joints of different robots to match the corresponding shape of each robot to generate dance motions and movements regardless of the different shapes of each robot.

The technical problems to be solved by the present disclosure are not limited to the aforementioned problems. Any other technical problems not mentioned herein should be clearly understood from the following description by those of ordinary skill in the art to which the present disclosure pertains.

According to an aspect of the present disclosure, an apparatus for generating a dance motion of a robot may include a memory configured to store computer-executable instructions. The apparatus further includes a processor coupled with the memory and configured to execute the computer-executable instructions to analyze music to be used to generate the dance motion and lyrics corresponding to the music to generate motion sets. Each of the motion sets is executable by a reference robot and generated for each predetermined unit of a plurality of predetermined units. The processor may be further configured to select one motion set, based on a result of proceeding with reinforcement learning for the motion sets by a predetermined epoch. The processor may be configured to proceed with additional reinforcement learning for the selected one motion set to calculate first control values of each of a plurality of joints of the reference robot. The processor may be configured to perform motion retargeting corresponding to a target robot based on the first control values to calculate second control values of each of a plurality of joints of the target robot.

In an embodiment, the processor may be configured to extract a beat and a tempo from the music, based on each of the motion sets executable by the reference robot being generated for each predetermined unit. The processor may be configured to segment the lyrics into a first segment in units of words, a second segment in units of sentences, and a third segment in units of beats. The processor may be configured to generate the motion sets respectively for the first segment, the second segment, and the third segment.

In an embodiment, the processor may be configured to extract the beat and the tempo from the music using a library for processing the music and an audio signal.

In an embodiment, the processor may input each of the first segment, the second segment, and the third segment to a pre-trained artificial intelligence-based language model to generate the motion sets for each segment, based on the motion sets being respectively generated for the first segment, the second segment, and the third segment.

In an embodiment, the language model may include an artificial intelligence-based model pre-trained to generate a motion corresponding to input lyrics and generate a robot executable code corresponding to the motion.

In an embodiment, the motion sets may include unit motions divided based on the predetermined unit and connection motions disposed between the unit motions.

In an embodiment, the processor may be configured to perform, based on the one motion set being selected, data pre-processing for proceeding with the reinforcement learning for the unit motions and the connection motions included in the motion sets based on the result of proceeding with the reinforcement learning for the motion sets by the predetermined epoch. The processor may be configured to configure a total reward function for each of the pre-processed motion sets. The processor may be configured to proceed with the reinforcement learning for each of the motion sets by the predetermined epoch to calculate reward scores according to the total reward function. The processor may be configured to select the one motion set among the motion sets based on the reward scores.

In an embodiment, the processor may be configured to map respectively corresponding lyrics, time, beat, and motion to the unit motions based on the data pre-processing being performed. The processor may be configured to map respectively corresponding time, beat, and motion to the connection motions.

In an embodiment, the total reward function may include a first reward function for the unit motions and a second reward function for the connection motions.

In an embodiment, motion retargeting may include converting a motion corresponding to the reference robot into a motion corresponding to the target robot, based on a length of a link, a configuration of the link, and a driving angle of the joint for the target robot.

According to another aspect of the present disclosure, a method for generating a dance motion of a robot may include analyzing music to be used to generate the dance motion and lyrics corresponding to the music to generate motion sets. Each of the motion sets is executable by a reference robot and is generated for each predetermined unit. The method further includes selecting one motion set, based on the result of proceeding with reinforcement learning for the motion sets by a predetermined proceeding epoch. The method includes with additional reinforcement learning for the selected motion set to calculate first control values of each of a plurality of joints of the reference robot. The method further includes performing motion retargeting corresponding to a target robot based on the first control values to calculate second control values of each of a plurality of joints of the target robot.

In an embodiment, generating each of the motion sets executable by the reference robot for each predetermined unit may include extracting a beat and a tempo from the music, segmenting the lyrics into a first segment in units of words, a second segment in units of sentences, and a third segment in units of beats, and generating the motion sets respectively for the first segment, the second segment, and the third segment.

In an embodiment, extracting the beat and the tempo from the music may include extracting the beat and the tempo from the music using a library for processing the music and an audio signal.

In an embodiment, generating the motion sets respectively for the first segment, the second segment, and the third segment may include inputting each of the first segment, the second segment, and the third segment to a pre-trained artificial intelligence-based language model to generate the motion sets for each segment.

In an embodiment, selecting the one motion set, based on the result of proceeding with the reinforcement learning for the motion sets by the predetermined epoch may include performing data pre-processing for proceeding with the reinforcement learning for the unit motions and the connection motions included in the motion sets, configuring a total reward function for each of the pre-processed motion sets, proceeding with the reinforcement learning for each of the motion sets by the predetermined epoch to calculate reward scores based the total reward function, and selecting the one motion set among the motion sets based on the reward scores.

In an embodiment, performing the data pre-processing may include mapping respectively corresponding lyrics, time, beat, and motion to the unit motions and mapping respectively corresponding time, beat, and motion to the connection motions.

### BRIEF DESCRIPTION OF THE DRAWINGS

The above and other objects, features and advantages of the present disclosure should be more apparent from the following detailed description taken in conjunction with the accompanying drawings:

FIG. 1 is a block diagram illustrating a configuration of an apparatus for generating a dance motion of a robot according to an embodiment of the present disclosure;

FIGS. 2-4 are flowcharts illustrating a method for generating a dance motion of a robot according to an embodiment of the present disclosure;

FIG. 5 is a drawing illustrating a process of generating a motion set executable by a reference robot in a predetermined first unit according to an embodiment of the present disclosure;

FIG. 6 is a diagram illustrating a process of generating a motion corresponding to lyrics input using a language model and generating a robot executable code corresponding to the motion according to an embodiment of the present disclosure;

FIG. 7 is a diagram illustrating data pre-processing according to an embodiment of the present disclosure;

FIG. 8 is a diagram illustrating a process of calculating a reward score according to an embodiment of the present disclosure; and

FIG. 9 is a block diagram illustrating a computing device according to an embodiment of the present disclosure.

v

### DETAILED DESCRIPTION

Various embodiments of the present disclosure are described below in detail with reference to the accompanying drawings. In the following drawings, the same reference numerals are used throughout to designate the same or equivalent elements, even though the elements are shown in different drawings. Further, in the following description of various embodiments, a detailed description of well-known functions and configurations incorporated therein has been omitted for the purpose of clarity and for brevity.

Additionally, various terms such as first, second, “A”, “B”, (a), (b), and the like used solely to differentiate one component from the other but not to imply or suggest the type, order, or sequence of the components. Furthermore, unless otherwise defined, all terms including technical and scientific terms used herein have the same meaning as being generally understood by those of ordinary skill in the art to which the present disclosure pertains. Such terms as those defined in a generally used dictionary are to be interpreted as having meanings equal to the contextual meanings in the relevant field of art and are not to be interpreted as having ideal or excessively formal meanings unless clearly defined as having such in the present application.

Throughout this specification, when a part ‘includes’ or ‘comprises’ a component, it is understood that the part may include other components unless specifically stated to the contrary. When a component, device, element, part, unit, module or the like of the present disclosure is described as having a purpose or performing an operation, function, or the like, the component, device, or element should be considered herein as being “configured to” meet that purpose or to perform that operation or function. Each “part”, “unit”, “module”, “component”, “device”, “element”, and the like may separately embody or be included with a processor and a memory, such as a non-transitory computer readable media, as part of the apparatus.

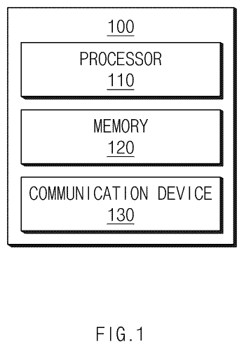

Hereinafter, embodiments of the present disclosure are described below in detail with reference to FIGS. 1-9.

FIG. 1 is a block diagram illustrating a configuration of an apparatus for generating a dance motion of a robot according to an embodiment of the present disclosure.

Referring to FIG. 1, an apparatus 100 for generating a dance motion of a robot may be a computable computing device. For example, the apparatus 100 for generating the dance motion of the robot may include a processor 110, a memory 120, and a communication device 130. According to various embodiments, the configuration of the apparatus 100 for generating the dance motion of the robot is not limited to the configuration shown in FIG. 1 and some components may be further added or omitted. In an embodiment, the apparatus 100 for generating the dance motion of the robot may further include an output device (not shown). For example, the output device of the apparatus 100 for generating the dance motion of the robot may include a display. The display may visually display music, lyrics, a dance motion, a control value, or the like.

In an embodiment, the processor 110 may be composed of one or more cores and may include a specifically configured processor for performing an operation associated with data processing, e.g., a central processing unit (CPU), a graphics processing unit (GPGPU), or a tensor processing unit (TPU) of the apparatus 100 for generating the dance motion of the robot.

The processor 110 may perform computations for training of an artificial intelligence-based model. For example, the processor 110 may perform calculations for training of the artificial intelligence-based model, such as processing of input data for training in deep learning, feature extraction from the input data, error calculation, or a weight update of the artificial intelligence-based model using backpropagation. The processor 110 may process learning of a network function. Furthermore, in an embodiment, the processor 110 may use processors of a plurality of computing devices to perform learning of the network function and data processing of the network function.

The processor 110 may control the overall operation of the apparatus 100 for generating the dance motion of the robot. The processor 110 may process a signal, data, information, or the like input or output via the components included in the apparatus 100 for generating the dance motion of the robot. The processor 110 may run an application program stored in the memory 120, thus providing or processing appropriate information or an appropriate function.

In an embodiment, the memory 120 may store any type of information generated or determined by the processor 110 and/or any type of information received by the communication device 130. For example, the memory 120 may store an artificial intelligence-based language model. The processor may execute computer-executable instructions and functions related to the artificial intelligence-based language model stored in the memory 120.

The memory 120 may include at least one type of storage medium among a flash memory type memory, a hard disk type memory, a multimedia card micro type memory, a card type memory (e.g., an SD or XD memory), a random access memory (RAM), a static RAM (SRAM), a read-only memory (ROM), an electrically erasable programmable ROM (EEPROM), a programmable ROM (PROM), a magnetic memory, a magnetic disc, and/or an optical disc. The apparatus 100 for generating the dance motion of the robot may operate in conjunction with web storage for performing a storage function of the memory 120 on the Internet. The above-mentioned description of the memory 120 is only an example and the present disclosure is not limited thereto.

The communication device 130 may include any wired and wireless communication network capable of transmitting and receiving any type of data, information, signal, and the like. The communication device 130 may communicate with an external device. The external device may include, for example, the robot.

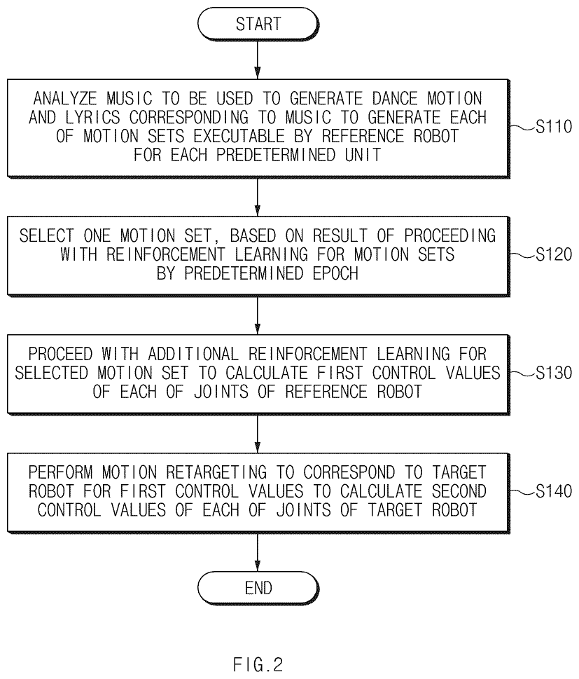

Hereinafter, a detailed description of a method for generating a dance motion of a robot is provided according to an embodiment of the present disclosure with reference to FIGS. 2-4. FIGS. 2-4 are flowcharts illustrating a method for generating a dance motion of a robot according to an embodiment of the present disclosure. Steps of FIGS. 2-4 may be performed by an apparatus 100 for generating a dance motion of a robot.

In various embodiments, the lyrics and the music may be segmented by the processor 110 in units, e.g., units of words, units of sentences, units of beats, and the like.

The terms predetermined units or segmentation units refer to criteria/options to segment the lyrics and the music and allows the apparatus 100 to flexibly choose one or more units based on model optimization, user preference, or performance requirements. In particular, predetermined units refer to a set of configurable criteria that may be selected in advance based on the application scenario and may include units of words, sentences, or beats, either individually or in combination.

In various embodiments, the lyrics may be segmented only by words (for fine-grained motion), while in others, sentence-based or beat-based segments may be used (for smoother transitions or alignment with rhythm).

Each segmentation unit may be predetermined manually or learned/adapted automatically based on reward values in the reinforcement learning process.

Referring to FIG. 2, in step S110, a processor 110 may analyze music to be used to generate a dance motion and may analyze lyrics corresponding to the music to generate each of a plurality of motion sets executable by a reference robot for each predetermined unit. In other words, the processor 110 may generate a set of movements executable by the reference robot using predetermined units by analyzing the music to be used in the generation of the dance movement and the lyrics corresponding to the music.

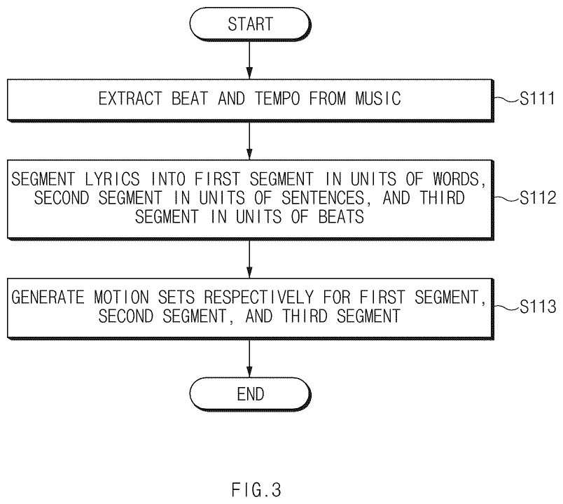

For example, referring to FIG. 3, in step S111, the processor 110 may extract a beat and a tempo from the music. In particular, the processor 110 may extract the beat and the tempo from the music using a library for processing the music and an audio signal.

In an embodiment, the library may refer to a function generated in advance to be usable for programming or a set of variables. The library may be a tool for providing functions frequently used by developers in a reusable form. For example, the library may include a function or a set of variables for processing pieces of information included in music (e.g., a beat, a tempo, intensity, or the like of the music).

In an embodiment, the library may include a Librosa library. The Librosa library may be a Python library for processing music and an audio signal. The processor 110 may extract a tempo, a beat, intensity, or the like of music using the Librosa library and may visualize it using a graph. The processor 110 may be used to fetch music using the Librosa library and extract a tempo, a beat timing, or the like of the music. In an embodiment, the extracted beat and/or tempo may be

used to learn a timing and a speed of a dance motion in a reinforcement learning step.

In step S112, the processor 110 may segment lyrics into a first segment in units of words, a second segment in units of sentences, and a third segment in units of beats.

In step S113, the processor 110 may generate motion sets respectively for the first segment, the second segment, and the third segment. For example, the processor 110 may generate a first motion set corresponding to the first segment, may generate a second motion set corresponding to the second segment, and may generate a third motion set corresponding to the third segment.

In an embodiment, the processor 110 may input each of the first segment, the second segment, and the third segment to a pre-trained artificial intelligence-based language model to generate the motion sets for each segment.

In an embodiment, the language model may include an artificial intelligence-based model pre-trained to generate a motion corresponding to input lyrics and generate a robot executable code corresponding to the motion.

In an embodiment, the language model may include a large language model (LLM). The LIM may refer to an artificial intelligence-based model trained using a huge amount of training data to perform natural language processing. The LLM may include a transformer, an encoder series model of the transformer, and/or a decoder series model of the transformer. The encoder series model of the transformer may correspond to an artificial intelligence model which uses an encoder structure of the transformer. The decoder series model of the transformer may correspond to an artificial intelligence (e.g., ChatGPT or the like) which uses a decoder structure of the transformer.

In an embodiment, the LIM may process various data formats, such as image data, audio data, and video data as well as natural language text.

Referring again to FIG. 2, in an embodiment, in S120, the processor 110 may select one motion set based on the result of proceeding with reinforcement learning for the motion sets by a predetermined learning cycle (epoch). In an embodiment, the motion sets may include unit motions divided based on the predetermined unit and connection motions between the unit motions.

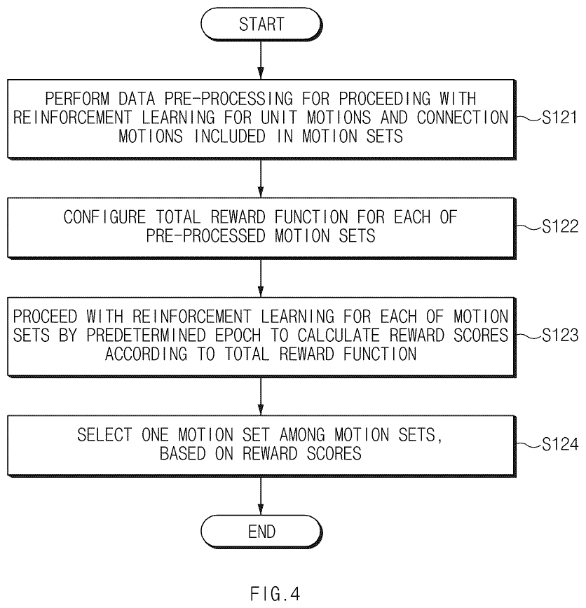

In particular, referring to FIG. 4, in step S121, the processor 110 may perform data pre-processing to proceed with reinforcement learning for the unit motions and the connection motions included in the motion sets.

Herein, the term “unit motion” refers to a basic motion segment that corresponds to a specific segment of lyrics (e.g., a word, sentence, or beat unit). These motions are independently generated to reflect the semantic or rhythmic meaning of the corresponding segment.

In contrast, a “connection motion” is a transitional motion that smoothly connects two adjacent unit motions, ensuring that the entire dance sequence flows naturally without abrupt or awkward transitions.

In other words, a unit motion refers to a core motion generated in association with an individual lyric or beat segment, while a connection motion refers to a transitional motion that smoothly bridges between adjacent unit motions.

These two types of motions are both used in the reinforcement learning stage, where rewards are calculated for how well the unit motions are executed and how smoothly the connection motions are integrated.

For example, the processor 110 may map respectively corresponding lyrics, time, beat, and motion to the unit motions. The processor 110 may map respectively corresponding time, beat, and motion to the connection motions.

In step S122, the processor 110 may configure a total reward function for each of the pre-processed motion sets.

In an embodiment, the reward function may refer to a function which represents a reward provided according to an action of an agent in reinforcement learning as a numerical value.

Learning may proceed such that the result value of the reward function becomes maximum in the reinforcement learning.

In an embodiment, the total reward function may include a first reward function for the unit motions and a second reward function for the connection motions.

The first reward function may be a function which represents a reward in a lyric set corresponding to each of the unit motions as a numerical value. For example, the first reward function may correspond to Equation 1 below.

$${R}_{segment motion} = a * {R}_{beatTime} + b * {R}_{jointSpeed} + c * {R}_{contextMotion} - d * {P}_{jointLimit} \qquad 〈 Equation 1 〉$$

Herein, R may be the reward. P may be the penalty. a, b, c, and d may be weights.

The second reward function may be a function that evaluates the smoothness of the transition between adjacent unit motions when a connection motion is used to connect them. In other words, the second reward function evaluates the smoothness or naturalness of the transitions between unit motions that are connected sequentially to form a complete motion sequence. For example, the second reward function may correspond to Equation 2 below.

$${R}_{transition motion} = e * {R}_{smoothness} \qquad 〈 Equation 2 〉$$

Herein, R may be the reward and e may be the weight.

The total reward function may correspond to Equation 3 below.

$${R}_{total} = \sum {R}_{segment motion} + \sum {R}_{transition motion} \qquad 〈 Equation 3 〉$$

The condition and the description for each item of Equations 1 to 3 described above may correspond to Table 1 below.

TABLE 1

| | Item | Condition | Description |
|---|---|---|---|
| R_segment | R_beatTime | Time (Joint control) == | Reward the agent, if |
| | | time (beat_time) | the joint control |
| | | | command value time |
| | | | point and the beat |
| | | | time are identical |
| | | | to each other |
| | R_jointSpeed | N (tempo) − allowable | Normalize the tempo |
| | | range < joint speed < | to match the joint |
| | | N (tempo) + allowable | speed and reward the |
| | | range | agent, if the joint |
| | | | speed is within the |
| | | | determined range |
| | R_contextMotion | Joint angle == target | Reward the agent, if |
| | | joint angle | performing the |
| | | | motion in which the |
| | | | lyrics information |
| | | | is reflected to be |
| | | | similar (joint |
| | | | angle values are |
| | | | identical to each |
| | | | other) |
| | P_jointLimit | Joint_angle > dof_ | Assign a penalty, if |
| | | limits_upper | the joint motion |
| | | orJoint_angle < dof_ | reaches the limits |
| | | limits_lower | of the range of motion |
| R_transition | R_smoothness | abs{Joint_angle_speed | Compare angular |
| | | (t + 1) − | velocity values of |
| | | joint_angle_speed (t)} < | respective joints |
| | | allowable range | of the connection |
| | | | motion between the |
| | | | previous epoch and |
| | | | the current epoch |
| | | | and reward the |
| | | | agent, if the |
| | | | angular velocity |
| | | | values are less than |
| | | | the allowable range |

In step S123, the processor 110 may proceed with reinforcement learning for each of the motion sets by a predetermined number of learning iterations, i.e., epochs (e.g., 1M epochs or the like) to calculate reward scores according to the total reward function. In other words, the processor 110 may train each of the motion sets based on reinforcement learning by a predetermined number of epochs, i.e., number of complete passes through the training data or training steps used to optimize the motion generation model. In step S124, the processor 110 may select one motion set among the motion sets, based on the reward scores. For example, the processor 110 may select one motion set with the highest reward score among the first motion set corresponding to the first segment in units of words, the second motion set corresponding to the second segment in units of sentences, and the third motion set corresponding to the third segment in units of beats.

Referring again to FIG. 2, in step S130, the processor 110 may proceed with additional reinforcement learning for the selected motion set to calculate first control values of each of the joints of the reference robot. For example, the processor 110 may proceed with the additional reinforcement learning for the selected motion set to calculate the first control values of each of the joints of the reference robot in a time sequence. In other words, the processor 110 may additionally train the selected motion set based on reinforcement learning to calculate the first control values.

In step S140, the processor 110 may perform motion retargeting to correspond to a target robot for the first control values to calculate second control values of each of joints of the target robot.

Herein, the first control values refer to joint-level control parameters (e.g., joint angles, joint torques, or joint position trajectories) calculated for each joint of a reference robot model based on reinforcement learning based on the selected motion set. The second control values are parameters derived by adapting the first control values to a target robot's structure and constraints, e.g., kinematic or dynamic constraints, through motion retargeting. In other words, the first control values include intermediate control outputs optimized for a virtual or standard robot model, e.g., a reference robot model, while the second control values are the final outputs applicable to the actual robot used for deployment, e.g., the target robot.

In an embodiment, the motion retargeting may refer to a technology for converting a motion of the reference robot such that the motion of the reference robot is applicable to the target robot which is another robot. For example, the motion retargeting may be used to apply the motion of the reference robot (e.g., a humanoid robot) to a robot model with a joint structure and a kinematic characteristic, which are different from the reference robot.

In an embodiment, the motion retargeting may include converting a motion corresponding to the reference robot into a motion corresponding to the target robot, based on a length of a link, a configuration of the link, and a driving angle of the joint for the target robot.

For example, although the target robot has the same joint structure as the reference robot, the length of each link, i.e., the link length or spatial relationship between joints, may vary. Thus, the processor 110 may convert an existing motion to be performed naturally and stably to match a new link length via the motion retargeting.

Furthermore, a driving angle each joint is able to have between robots may vary. For example, the joint of the reference robot may rotate at 180 degrees, whereas the target robot may rotate at only 90 degrees depending on motor driving and hardware specifications. Thus, the processor 110 may reflect limitations to re-generate a motion within a range performable by the target robot via the motion retargeting.

Furthermore, if the target robot differs from the reference robot structurally in the number of links or a connection scheme of the links, the processor 110 may re-generate an original motion to match a structure of the target robot via the motion retargeting. For example, the processor 110 may re-generate a motion of the reference robot as a motion of a four-legged robot, a motion of a robot with a tail, or the like.

In an embodiment, the motion retargeting may include a method for selecting a joint of the target robot, which is manually matched with a joint of an input reference robot and allowing the target robot to follow an original motion of the reference robot.

In an embodiment, the motion retargeting may include a method for using motion consistency with the input reference robot as a variable of a reinforcement learning reward function via the reinforcement learning. In other words, the motion retargeting may include a method for training the motion of the reference robot and the motion of the target robot in a direction in which the motion of the reference robot and the motion of the target robot are as similar as possible via the reinforcement learning.

In an embodiment, the motion retargeting may include a method using a cycle generative adversarial network (GAN) model which is an artificial intelligence-based model.

In an embodiment, the cycle GAN model may be an unsupervised learning model for learning transformation between two different domains. The cycle GAN model may be composed of two generators and two discriminators.

The two generators may include a first generator for converting domain data of the reference robot into domain data of the target robot and a second generator for converting domain data of the target robot into domain data of the reference robot.

The discriminators may perform learning for evaluating how similar the converted data is to original domain data to increase a similarity via mutual feedback.

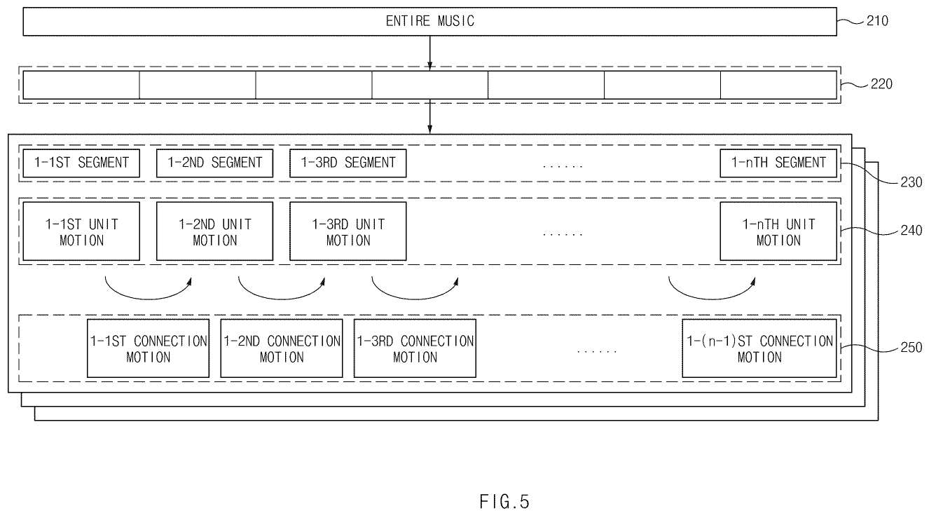

FIG. 5 is a drawing illustrating a process of generating a motion set executable by a reference robot in a predetermined first unit according to an embodiment of the present disclosure. A detailed description of functions and configurations already described with reference to FIGS. 1-4 may be omitted with reference to FIG. 5 for the purpose of clarity and for brevity.

Referring to FIG. 5, a processor 110 may fetch music to be used to generate a dance motion and lyrics 210 corresponding to the music. For example, the processor 110 may fetch music and lyrics, which are previously stored in a memory 120 or are received from an external device via a communication device 130.

The processor 110 may extract a beat and tempo 220 from the music.

The processor 110 may segment lyrics into a segment for each unit. For example, the processor 110 may segment the lyrics into a first segment 230 in units of words. The first segment 230 may include a 1-1st segment, a 1-2nd segment, . . . , a 1-nth segment, which are segmented based on word units. Herein, n may be a natural number.

The processor 110 may generate a motion set for the segment. For example, the processor 110 may generate first unit motions 240 for the first segment 230. The first unit motions 240 may include a 1-1st unit motion, a 1-2nd unit motion, . . . , a 1-nth unit motion. Herein, n may be a natural number. The processor 110 may generate first connection motions 250 between the unit motions 240. The first connection motions 250 may include a 1-1st connection motion, a 1-2nd connection motion, . . . , a 1-(n−1) st connection motion. Herein, n may be a natural number.

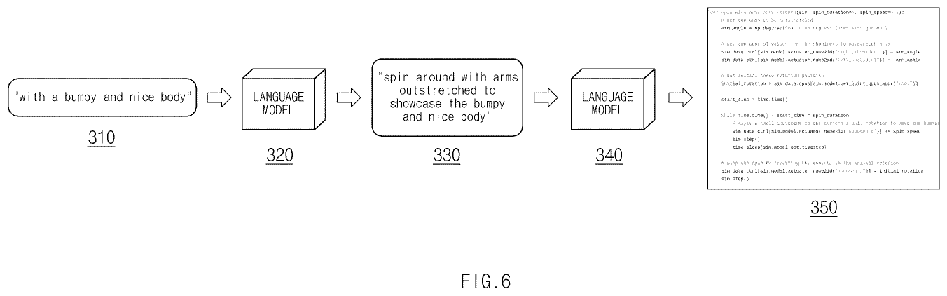

FIG. 6 is a diagram illustrating a process of generating a motion corresponding to lyrics input using a language model and generating a robot executable code corresponding to the motion according to an embodiment of the present disclosure. A detailed description of functions and configurations already described with reference to FIGS. 1-5 may be omitted below with reference to FIG. 6 for the purpose of clarify and for brevity.

Referring to FIG. 6, a processor 110 may input lyrics 310 to a language model 320, i.e., a first language model 320, to generate a motion 330 corresponding to the lyrics 310. For example, the processor 110 may input the lyrics 310 and a prompt to the language model 320 to generate the motion 330 corresponding to the lyrics 310.

In an embodiment, the prompt may be a target to be processed by the language model 320, which may refer to data written by a user. For example, the prompt may have various forms, such as a question, a request, a command, and/or a description, which are/is input to interact with the language model 320. For example, the prompt may take a form of text, an image, a voice, and/or a video to be input to the language model 320. In an embodiment, the prompt may be “Generate a dance motion matching these lyrics!”.

The processor 110 may input the motion 330 to a language model 340, i.e., a second language model, to generate a robot executable code 350 corresponding to the motion 330. For example, the processor 110 may input the motion 330 and the prompt to the language model 340 to generate the robot executable code 350 corresponding to the motion 330. Herein, the prompt may be “Please write the generated motion into a code performable by a humanoid robot!”. In an embodiment, the language model 320 and the language model 340 may correspond to each other.

In an embodiment, the robot executable code 350 may refer to a set of computer-executable instructions executable by the processor 110 or a computer.

The processor 110 may use the language models 320 and 340 to generate a dance motion even without a dance motion database or previous data, such as a video.

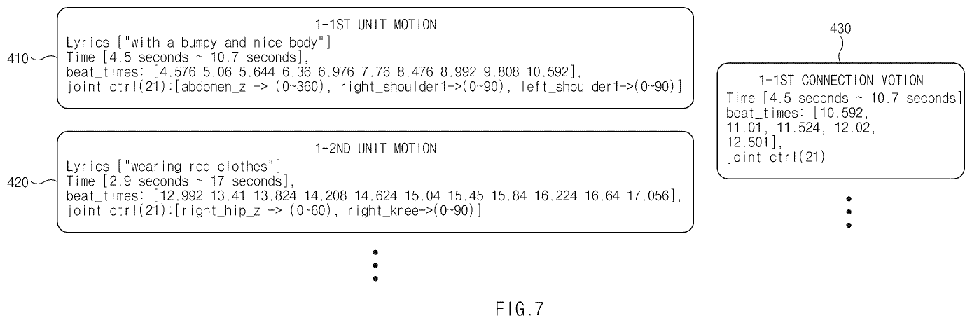

FIG. 7 is a drawing illustrating data pre-processing according to an embodiment of the present disclosure. A detailed description of functions and configurations already described with reference to FIGS. 1-6 may be omitted below with reference to FIG. 7 for the purpose of clarify and for brevity.

Referring to FIG. 7, a processor 110 may map respectively corresponding lyrics, time, beat, and motion to unit motions. In an embodiment, the processor 110 may map corresponding lyrics, time, beat, and motion to a 1-1st unit motion 410 to represent the corresponding lyrics, time, beat, and motion as one set. In another embodiment, the processor 110 may map corresponding lyrics, time, beat, and motion to a 1-2nd unit motion 420 to represent the corresponding lyrics, time, beat, and motion as one set.

The processor 110 may map respectively corresponding time, beat, and motion to the connection motions. In an embodiment, the processor 110 may map a corresponding time, beat, and motion to a 1-1st connection motion 430 which is a connection motion between the 1-1st unit motion 410 and the 1-2nd unit motion 420 to represent the corresponding time, beat, and motion as one set.

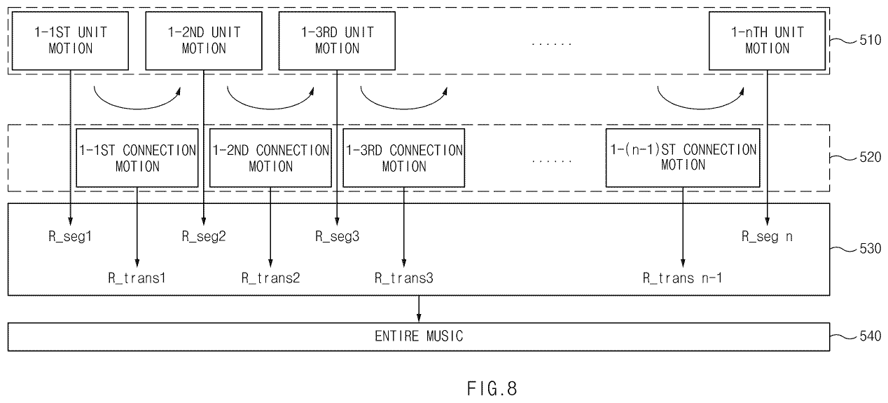

FIG. 8 is a drawing illustrating a process of calculating a reward score according to an embodiment of the present disclosure. A detailed description of functions and configurations already described with reference to FIGS. 1-7 may be omitted with reference to FIG. 8 for the purpose of clarify and for brevity.

Referring to FIG. 8, a processor 110 may configure a total reward function 530 for a first segment. In detail, the processor 110 may configure a reward function for each of first unit motions 510 and first connection motions 520 to configure the total reward function 530.

The processor 110 may proceed with reinforcement learning by a predetermined cycle to calculate a first reward score 540 according to the total reward function 530. For example, the processor 110 may proceed with the reinforcement learning by the predetermined cycle to calculate the sum of all reward functions for each of the first unit motions 510 and the first connection motions 520.

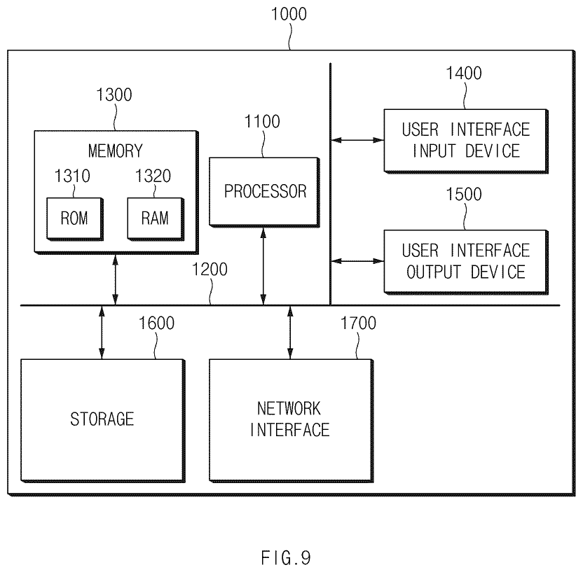

FIG. 9 illustrates a computing device according to an embodiment of the present disclosure. The computing system may correspond to some of the components of an apparatus for generating a dance motion of a robot according to an embodiment of the present disclosure.

Referring to FIG. 9, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Thus, the operations of the method or the algorithm described in connection with the embodiments disclosed herein may be embodied directly in hardware or a software module executed by the processor 1100, or in a combination thereof. The software module may reside on a storage medium (i.e., the memory 1300 and/or the storage 1600) such as a RAM, a flash memory, a ROM, an EPROM, an EEPROM, a register, a hard disc, a removable disk, and a CD-ROM.

The storage medium may be coupled with the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

An embodiment of the present disclosure may identify the entire contents of music regarding the meaning of lyrics, as well as elements, such as a beat and a rhythm of the music, for generating a dance motion of a robot and may generate a motion that matches the lyrics and the beat.

An embodiment of the present disclosure may allow the robot to generate its motion by itself even without a guide, such as a video.

An embodiment of the present disclosure may automatically map movement of a joint to match a shape of the robot to generate a dance motion even for robots with various shapes.

In addition, various effects ascertained directly or indirectly through the present disclosure may be provided.

Although the present disclosure has been described with reference to various embodiments and the accompanying drawings for illustrative purposes, the present disclosure is not limited thereto. Those of ordinary skill in the art should appreciate that various modifications, additions, and substitutions are possible, without departing from the spirit and scope of the claimed disclosure.

Accordingly, embodiments of the present disclosure are intended not to limit but to explain the technical idea of the present disclosure. One of ordinary skill in the art would understand that the scope and spirit of the disclosure is not limited by the above described embodiments but by the accompanying claims and equivalents thereof.

What is claimed is:

1. An apparatus for generating a dance motion of a robot, the apparatus comprising:
a memory configured to store computer-executable instructions;
a processor coupled with the memory, wherein the processor is configured to execute the computer-executable instructions to:
analyze music to be used to generate the dance motion and lyrics corresponding to the music to generate motion sets, each of the motion sets being executable by a reference robot and being generated for each predetermined unit of a plurality of predetermined units;
select one motion set based on a result of proceeding with reinforcement learning for the motion sets by a predetermined epoch;
proceed with additional reinforcement learning for the selected one motion set to calculate first control values of each of a plurality of joints of the reference robot; and
perform motion retargeting corresponding to a target robot based on the first control values to calculate second control values of each of a plurality of joints of the target robot.

2. The apparatus of claim 1, wherein the processor is configured to:
extract a beat and a tempo from the music, based on generating each of the motion sets executable by the reference robot for each predetermined one of a unit of words, a unit of sentences, or a unit of beats;
segment the lyrics into a first segment in units of words, a second segment in units of sentences, and a third segment in units of beats; and
generate the motion sets respectively for the first segment, the second segment, and the third segment.

3. The apparatus of claim 2, wherein the processor is configured to:
extract the beat and the tempo from the music using a library for processing the music and an audio signal.

4. The apparatus of claim 2, wherein the processor is configured to:
input each of the first segment, the second segment, and the third segment to a pre-trained artificial intelligence-based language model to generate the motion sets for each segment based on the motion sets being respectively generated for the first segment, the second segment, and the third segment.

5. The apparatus of claim 4, wherein the language model includes an artificial intelligence-based model pre-trained to generate a motion corresponding to input lyrics and generate a robot executable code corresponding to the motion.

6. The apparatus of claim 1, wherein the motion sets include:
unit motions divided based on the predetermined unit; and
connection motions disposed between the unit motions.

7. The apparatus of claim 6, wherein the processor is configured to:
perform, based on the one motion set being selected, data pre-processing for proceeding with the reinforcement learning for the unit motions and the connection motions included in the motion sets based on the result of proceeding with the reinforcement learning for the motion sets by the predetermined epoch;
configure a total reward function for each of the pre-processed motion sets;
proceed with the reinforcement learning for each of the motion sets by the predetermined epoch to calculate reward scores based on the total reward function; and
select the one motion set among the motion sets, based on the reward scores.

8. The apparatus of claim 7, wherein the processor is configured to:
map respectively corresponding lyrics, time, beat, and motion to the unit motions, based on the data pre-processing being performed; and
map respectively corresponding time, beat, and motion to the connection motions.

9. The apparatus of claim 7, wherein the total reward function includes:
a first reward function for the unit motions; and
a second reward function for the connection motions.

10. The apparatus of claim 1, wherein motion retargeting includes converting a motion corresponding to the reference robot into a motion corresponding to the target robot based on a length of a link, a configuration of the link, and a driving angle of the joint for the target robot.

11. A method for generating a dance motion of a robot, the method comprising:
analyzing music to be used to generate the dance motion and lyrics corresponding to the music to generate motion sets, each of the motion sets being executable by a reference robot and generated for each predetermined unit of a plurality of predetermined units;
selecting one motion set, based on a result of proceeding with reinforcement learning for the motion sets by a predetermined epoch;
proceeding with additional reinforcement learning for the selected one motion set to calculate first control values of each of a plurality of joints of the reference robot; and
performing motion retargeting corresponding to a target robot based on the first control values to calculate second control values of each of a plurality of joints of the target robot.

12. The method of claim 11, wherein generating each of the motion sets executable by the reference robot for each predetermined unit includes:
extracting a beat and a tempo from the music;
segmenting the lyrics into a first segment in units of words, a second segment in units of sentences, and a third segment in units of beats; and
generating the motion sets respectively for the first segment, the second segment, and the third segment.

13. The method of claim 12, wherein extracting the beat and the tempo from the music includes:
extracting the beat and the tempo from the music using a library for processing the music and an audio signal.

14. The method of claim 12, wherein generating the motion sets respectively for the first segment, the second segment, and the third segment includes:
inputting each of the first segment, the second segment, and the third segment to a pre-trained artificial intelligence-based language model to generate the motion sets for each segment.

15. The method of claim 14, wherein the language model includes an artificial intelligence-based model pre-trained to generate a motion corresponding to input lyrics and generate a robot executable code corresponding to the motion.

16. The method of claim 11, wherein the motion sets include:
unit motions divided according to the predetermined unit; and
connection motions disposed between the unit motions.

17. The method of claim 16, wherein selecting of the one motion set based on the result of proceeding with the reinforcement learning for the motion sets by the predetermined epoch includes:
performing data pre-processing for proceeding with the reinforcement learning for the unit motions and the connection motions included in the motion sets;
configuring a total reward function for each of the pre-processed motion sets;
proceeding with the reinforcement learning for each of the motion sets by the predetermined epoch to calculate reward scores based on the total reward function; and
selecting the one motion set among the motion sets based on the reward scores.

18. The method of claim 17, wherein performing the data pre-processing includes:
mapping respectively corresponding lyrics, time, beat, and motion to the unit motions; and
mapping respectively corresponding time, beat, and motion to the connection motions.

19. The method of claim 17, wherein the total reward function includes:
a first reward function for the unit motions; and
a second reward function for the connection motions.

20. The method of claim 11, wherein the motion retargeting includes converting a motion corresponding to the reference robot into a motion corresponding to the target robot, based on a length of a link, a configuration of the link, and a driving angle of the joint for the target robot.
